(19) United States
(12) Patent Application Publication
(10) Pub. No.: US 2025/0320934 A1
(43) Pub. Date: Oct. 16, 2025

(54) RV Hookup Organizer

(71) Applicant: Phillip Allen, Anderson, SC (US)

(72) Inventor: Phillip Allen, Anderson, SC (US)

(73) Assignee: Distinctive Goods LLC, Anderson, SC (US)

(21) Appl. No.: 19/252,472

(22) Filed: Jun. 27, 2025

Related U.S. Application Data
(63) Continuation-in-part of application No. 18/370,217, filed on Sep. 19, 2023.

(51) Int. Cl. F16L 3/02; B60R 15/00; F16L 3/26

(52) U.S. Cl. CPC F16L 3/02; B60R 15/00; F16L 3/26

(57) ABSTRACT

An RV hookup organizer comprising a plurality of segments is disclosed. Each segment has an integral end portion pivotally joined to an integral end portion of an adjacent segment. Each segment has an integral bottom surface spaced from an integral cradled upper surface. The cradled upper surface defines a first integral surface depression, a second integral surface depression, and a third integral surface depression. The first surface depression is sized and configured to cradle or support a liquid/solid waste conduit. The second depression, spaced from the first depression, is sized and configured to cradle or support a power cable. The third depression, spaced from the first and second surface depressions, is dimensioned and configured to cradle or support a water pipeline.

### REFERENCE TO RELATED APPLICATION

This patent application is a continuation-in-part (“CIP”) of U.S. nonprovisional patent application Ser. No. 18/370,217 filed Sep. 19, 2023, and published Mar. 20, 2025, as US published patent application 2025/0092966, which is hereby incorporated by reference in its entirety for purposes of priority pursuant to Title 35, US Code Section 120.

### FIELD

The present subject matter is directed, in general, to an organizer for recreational vehicle (“RV”) connections, and more particularly, to a structural mechanism designed, adapted, and configured to organize and support three common utility (electrical, fresh water, and sewer) connections (“hookups”) between an RV and its camping/parking spot.

### BACKGROUND

Waste evacuation attachments for recreational vehicles are disclosed in U.S. Pat. No. 4,133,347 to Mercer; U.S. Pat. No. 4,231,595 to Knutsen; and U.S. Pat. No. 4,844,121 to Duke. Also, US publication 2025/0034854 to Benson discloses RV waste management systems.

U.S. Pat. No. 5,067,679 to Courtney discloses a support structure designed for a flexible waste hose from a recreational vehicle. U.S. Pat. No. 9,437,983 to Casale discloses an electrical connection box configured for recreational vehicles. U.S. Pat. No. 11,287,096 to Allen discloses a light fixture for mounting in a surface opening of a recreational vehicle.

U.S. Pat. No. 6,352,086 to Harper discloses a pressure relief mechanism, placed in line with a water supply hose for a recreational vehicle, to facilitate bleeding off back pressure when disconnecting the hose from a water hook-up. US published application 2006/0086390 to Warming discloses a fluid fill hook up assembly for recreational vehicles.

Furthermore, while U.S. Pat. No. 6,619,596 to Caine et al. discloses RV sewer hose supports; while U.S. Pat. No. 7,425,028 to Angel et al. discloses a handle and sewer hose support combination; and while U.S. Pat. No. 11,208,057 to Su discloses an RV hose support with adjustable supporting height feature, my review of the prior art could not find a single RV hookup organizer for a sewer hose, a water hose, and an electrical power connection.

Indeed, while traditional RV sewer support organizers are designed to handle only sewer hoses, modern RV owners have more organizational needs than sewer hoses only. See, e.g., U.S. Pat. No. 5,141,017 to Trottier, hereby incorporated by reference in its entirety.

The present subject matter thus allows RV owners to organize their hookups. The present subject matter has plural extendable-and-retractable interconnected segments. Each has three “U”-shaped upper-surface-aligned cradles to support respective ones of at least three RV amenities including a sewer hose, a water hose, and an electrical cord.

### SUMMARY

My RV hookup organizer is designed, sized, and configured to solve a variety of RV-related RV problems. Accordingly, an RV hookup organizer illustrating principles of the present subject matter shall now be summarized. The hookup organizer comprises a plurality of segments. Each of the plural segments has an integral end portion pivotally joined to an adjacent one of the plural segments. Also, an end portion of one segment is pivotally joined to an end portion of an adjacent segment, seriatim, along a length of plural segments. Each of the plural segments has an integral bottom surface; and each segment of the plural segments defines a cradled upper surface spaced from its bottom surface.

The cradled upper surface defines a first integral surface depression, a second integral surface depression, and a third integral surface depression. The first integral surface depression is dimensioned and configured to cradle or support a solid/liquid waste conduit. The second integral surface depression is spaced from the first surface depression. The second integral surface depression is dimensioned and configured to cradle or support a power cable. The third integral surface depression is spaced from the first surface depression as well as from the second surface depression. The third integral surface depression is dimensioned and configured to cradle or support a water pipeline.

### BRIEF DESCRIPTION OF THE DRAWING FIGURES

FIG. 1 presents a partially fragmented (also called a “cutaway”) perspective view of a recreational vehicle (“RV”), showing the vehicle's self-contained plumbing system including a so-called “gray-water” holding tank and a so-called “black-water” holding tank.

FIG. 2 is an exterior surface panel of the RV of FIG. 1, showing a power connection port, a sewer hose and/or liquid waste-connection port, and a fresh-water connection port.

FIG. 3 presents an exemplary perspective view of a portion of an RV hookup, operatively supporting sewer takeaway, electrical-power supply, and fresh-water supply.

FIG. 4 is a perspective view of a plurality of support components of the present subject matter, spaced closely together where each of the plural components includes integral end portions configured to be pivotally joined to at least one adjacent component.

FIG. 5 presents a perspective view of the plurality of support components shown in FIG. 4, depicting the support components spaced apart, with each support component pivotally joined to one or two immediately adjacently spaced-apart support components.

Throughout the FIGS. and the detailed description of this patent application, similar reference numerals are used to refer to related components of the present subject matter.

### DETAILED DESCRIPTION

In FIG. 1, a motorhome recreational vehicle 20 is shown to have a galley sink 22, a bathroom sink 24, a shower 26, and a toilet 28. The recreational vehicle 20 stores fresh water in a fresh water holding tank 30, supplied by a water pump 32 to a hot water heater 34, as well as to the galley sink 22, the bathroom sink 24, the shower 26, and the toilet 28. Hot water provided by the hot water heater 34 is supplied to the galley sink 22, the bathroom sink 24, and the shower 26. Waste water from the galley sink 22, the bathroom sink 24, and the shower 26 is routed into a gray-water holding tank 36. Moreover, waste from the toilet 28 is routed into a black-water holding tank 38. Thus, for the recreational vehicle 20 shown in FIG. 1, storage of gray water is maintained in the gray-water holding tank 36, while storage of the black water is maintained in the black-water holding tank 38.

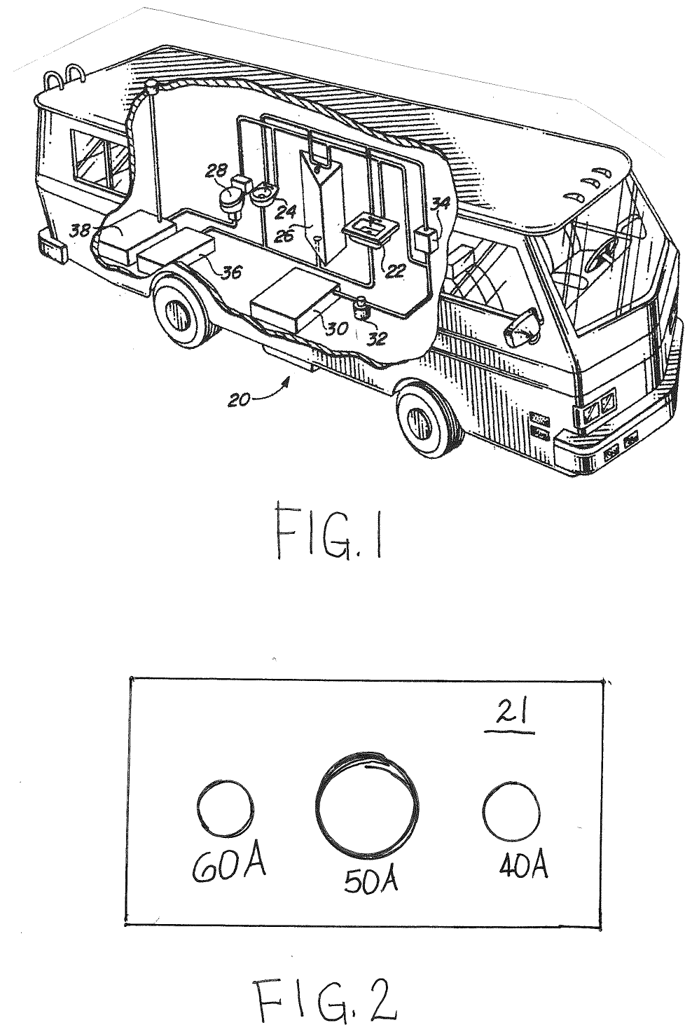

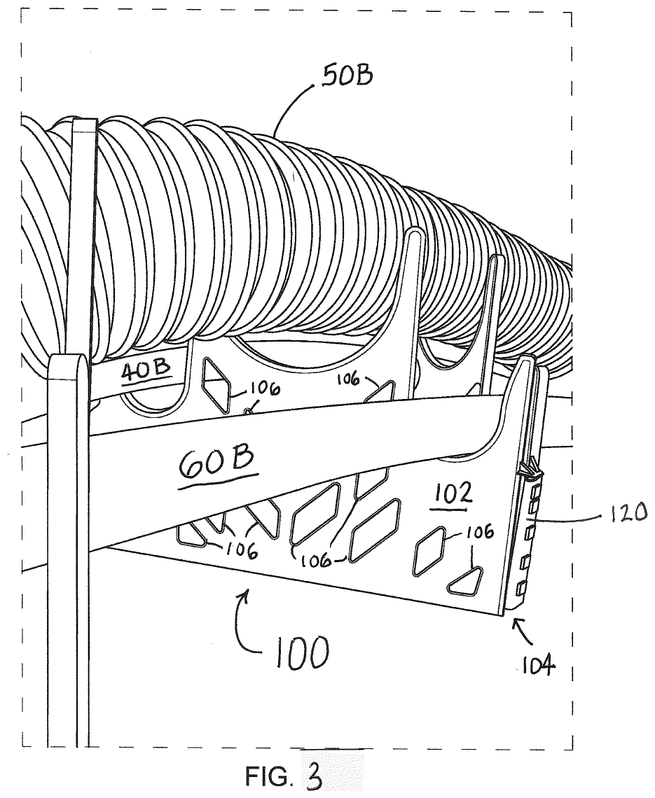

FIG. 2 is an exterior surface portion 21 of RV 20 depicting a power connection port 40A, a sewer hose or waste-connection port 50A, and a fresh-water connection port 60A. One purpose of the RV hookup organizer 100 of the present subject matter is to organize and support three common utility connections, or hookups, namely, an electrical power connection, and a sewer or waste connection, as well as a fresh-water connection, between the recreational vehicle 20 (FIG. 1) and its designated camping or parking spot.

FIGS. 3-5, an illustrative embodiment of the present subject matter (my invention), shall now be described in detail. FIG. 3 presents an exemplary fragmented section of the RV hookup organizer 100 of the present subject matter-my invention-in an operative (or “operational”) mode for which my hookup organizer 100 was designed, dimensioned, configured and structurally supported, and manufactured. For instance, FIG. 3 illustratively depicts my RV hookup organizer 100 supporting not only a power connection 40B but also a sewer hose or waste connection 50B and a fresh-water connection 60B.

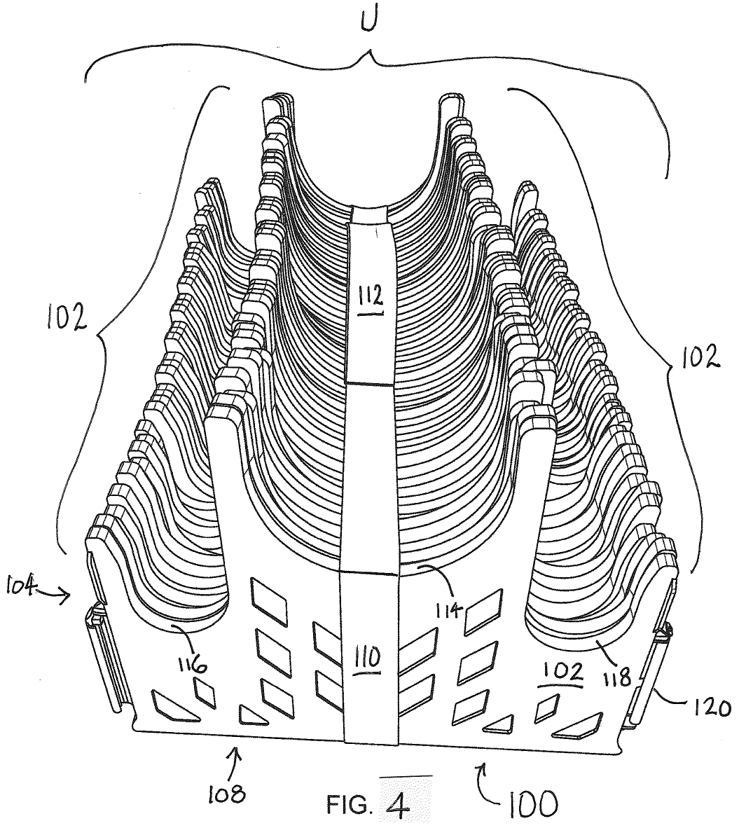

FIG. 4 is a perspective view of a plurality of support components of the present subject matter, spaced closely together, where each of the plural components includes integral end portions configured to be pivotally joined to at least one adjacent component.

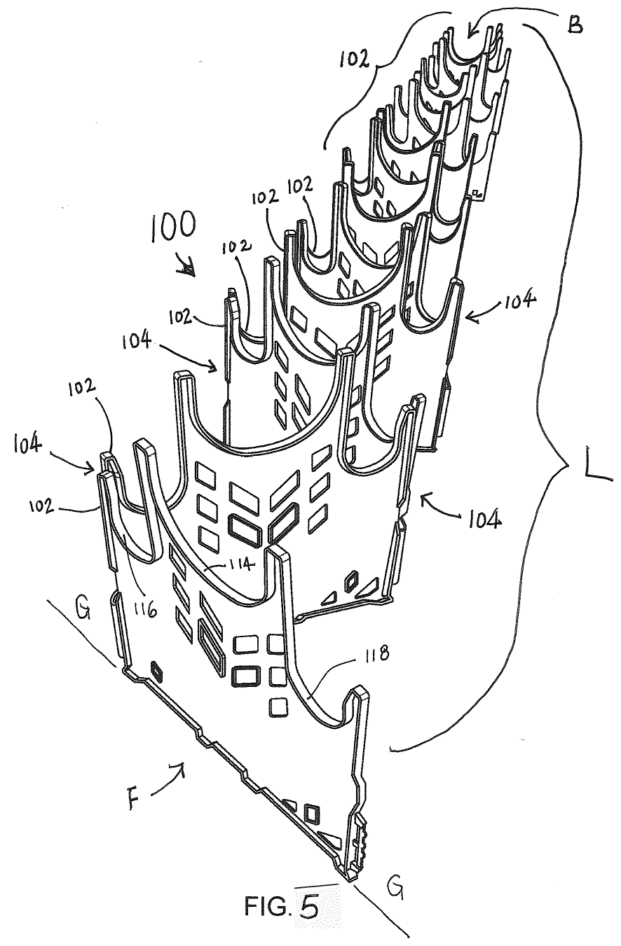

The RV hookup organizer 100 of the present subject matter-my invention-comprises a plurality of substantially planar segments 102 (FIG. 4). Each segment 102 is pivotally joined to an adjacent segment 102 in a seriatim manner along an end portion 104 (FIG. 5) of both segments 102 along the entire length (L) of the RV hookup organizer.

Each substantially planar segment 102 may include one or more apertures 106 (FIG. 3). Each segment 102 of the RV hookup organizer 100 has a substantially planar bottom surface 108 (FIG. 4) designed for placement upon a similarly substantially planar surface, such as the ground (not shown). The RV hookup organizer 100 is expandable (FIG. 5) for operable use and is compactable (FIG. 4) for storage or transport purposes.

The RV hookup organizer 100 also comprises means for releasably securing the plurality of substantially planar segments 102 together in closely abutting engagement. One version contemplates a flexible strap (not shown) having opposite end portions, where each of its end portions has one half (either the hooked end or the looped end) of a hook-and-loop (i.e., VELCRO) closure (not shown) and the bottom surface 108 has the other half of the hook-and-loop (i.e., VELCRO) closure. Another version contemplates a rigid strap 110, snap-engageable with the bottom surface 108 (FIG. 4) of an end segment 102 as the means for releasably securing the plurality of substantially planar segments 102 together in closely abutting engagement. The strap 110 is sized and configured for releasably securing segments 102 in seriatim butting engagement for storage or transport purposes. The strap 110 includes a handle 112 to facilitate transport of the organizer 100. Various other strap-and-handle combinations, including a strap-and-handle combination disclosed in U.S. Pat. No. 7,425,028 to Angel et al. (hereby incorporated by reference in its entirety), can be adapted for use with my RV hookup organizer 100 (see, e.g., FIGS. 3-5).

A product sold under the registered trademark “VELCRO” is not only the name of a company but also used by consumers to refer to the product itself is, of course, incorrect since a trademark is only to be used as an adjective, by referring to the brand under which the product is sold and never to be used as a noun to refer to the product itself. Thus, as background, first the company, then the product: VELCRO—officially known as Velcro IP Holdings LLC and trading as Velcro Companies—is a British privately held company, founded by the Swiss electrical engineer George de Mestral in the 1950s, the original manufacturer of hook-and-loop fasteners, which Mr. de Mestral invented. Hook-and-loop fasteners are well known. See, e.g., U.S. Pat. No. 4,447,060 to Guinn; U.S. Pat. No. 4,488,323 to Colburn; and U.S. Pat. No. 4,498,615 to Johnson. Indeed, many Velcro® brand products, including strips of hook-and-loop fasteners, are available online at www.textol.com/velcro.

The segments 102 of the RV hookup organizer 100 may be manufactured from any commercially available material—including but not limited to wooden, polymeric, and/or composite material—so long as the weight of the RV hookup organizer 100, based on the total number of substantially planar segments 102, does not exceed thirty pounds.

Before the RV hookup organizer 100 can be used, the strap 110 (FIG. 4) must be removed and pivotally joined segments 102 must be spaced apart in a seriatim manner relative to adjacent segments 102, to provide the length L for the organizer 100 (FIG. 5).

Two versions of the segments 102 may be derived from FIGS. 3-5. One version is where the plural segments 102 are all similarly sized. Another version is where the plural segments 102 are sized to be progressively smaller from a front (F) to a back B (FIG. 5).

An upper (U) surface of each substantially planar segment 102 (FIG. 4) has been dimensioned, designed, adapted, and configured to define a plurality of integral cradles or surface depressions. For instance, a central surface depression 114 has been sized, designed, adapted, and configured to cradle or support a common sewer hose or waste connection or conduit 50B (FIG. 3). Another upper surface depression 116 spaced from the central surface depression 114 along an upper end portion of its substantially planar segment 102, has been sized, designed, adapted, and configured to cradle or support a standard voltage-and-amperage electrical power supply-line, connection, or cable 40B. Yet another upper surface depression 118, spaced from the central surface depression 114 along an opposite upper end portion of its substantially planar segment 102 and spaced even further away from the upper surface depression 116 (FIG. 4), is sized, designed, adapted, and configured to cradle or support a common portable-water and/or fresh-water conduit or pipeline 60C connected to an available water source (not shown).

For the plural planar segments 102, each segment 102 is pivotally joined to an adjacent segment 102 in a seriatim manner along an end portion 104 (FIG. 5) of both segments 102 along the total length (L) of the RV hookup organizer. Each pivotally joined end portion 104 comprises complementary end portions of a two-unique-piece-portioned releasably securable hinge 120 (FIGS. 3, 4) unitary with its respective planar segment 102. Each end portion 104 of a pair of adjacent end portions 104 has one portion of a two-portioned releasably securable hinge 120 affixed thereto. (In other words, the hinge 120 comprises a pir of unique-piece portions.) The hinged design thus allows the RV hookup organizer 100 to be expanded for use as shown in FIGS. 3 and 5. The cradles 114, 116, and 118 (FIG. 4) start at one height above the ground, gradually sloping to lower height, to enable proper drainage for the sewer hose or liquid/solid waste connection 50B.

Accordingly, one prototype of the RV hookup organizer 100, a 20-ft model, had its front (F) segment 102 designed and manufactured whereby a low point for its cradle 114 (FIG. 5) for the sewer hose or waste connection 50B is spaced from about 7 inches above the ground down to about 4 inches above the ground for its back (B) or final segment 102.

For the embodiment noted above, the RV hookup organizer 100 of the present subject matter, is made so that each segment 102 (of the plural segments 102 of the RV hookup organizer 100) is progressively reduced in size from the front (F) to the back (B) of the RV hookup organizer 100 (FIG. 5). The RV hookup organizer 100 of the present subject matter has been designed to be compactable (FIG. 4) for storage and/or transport purposes; and the RV hookup organizer 100 is designed and configured to be extendable. Current embodiments of the RV hookup organizer 100 of the present subject matter are ca. 10-feet, 15-feet, and 20-feet in length (L). See, e.g., FIG. 5. Other embodiments of the RV hookup organizer 100 of the present subject matter can be made of custom lengths.

What has been described in detail throughout this patent specification and illustrated by the accompanying drawing figures is an RV hookup organizer. While the present subject matter has been described with reference to exemplary embodiments, the present subject matter is not limited to the embodiments shown and described herein. On the contrary, alternatives, changes, and/or modifications will be apparent to a person of ordinary skill in the art after this patent specification and its figures have been reviewed. Therefore, alternatives, changes, and/or modifications shall be treated as forming a part of the present subject matter insofar as they fall within the spirit and scope of the claims.

I claim:

1. An RV hookup organizer (100), comprising:
a plurality of segments (102), wherein each segment (102) of the plurality of segments (102) has an integral end portion (104) pivotally joined to an adjacent segment (102) of one of the plurality of segments (102), wherein each segment (102) includes an integral bottom surface (108), and wherein each segment (102) defines a cradled upper surface (U) spaced from the bottom surface (108),
wherein each cradled upper surface (U) defines:
a first integral surface depression (114) sized, adapted, and configured to cradle a waste conduit (50B);
a second integral surface depression (116) spaced from the first surface depression (114), wherein the second integral surface depression (116) is sized, adapted, and configured to cradle a power cable (40B); and
a third integral surface depression (118) spaced from the first and the second surface depressions (114, 116), wherein the third integral surface depression (118) is sized and configured to cradle a water pipeline (60B).

2. The RV hookup organizer (100) of claim 1, further comprising a releasably securable hinge 120, wherein each one end portion (104) of a pair of adjacent end portions (104) has one portion of a two-portioned releasably securable hinge (120) affixed thereto.

3. The RV hookup organizer (100) of claim 1, wherein the organizer (100) has a front (F) and a back (B), and wherein each segment (102) of the plurality of segments (102) is progressively reduced in size from the front (F) to the back (B) of the organizer (100).
